(19) United States
(12) Patent Application Publication
(10) Pub. No.: US 2013/0292962 A1
(43) Pub. Date: Nov. 7, 2013

(54) Stroller Canopy Shades

(71) Applicant: Robin Jean Romanow, Howell, NJ (US)

(72) Inventor: Robin Jean Romanow, Howell, NJ (US)

(21) Appl. No.: 13/861,656

(22) Filed: Apr. 12, 2013

Related U.S. Application Data
(60) Provisional application No. 61/623,715, filed on Apr. 13, 2012.

(51) Int. Cl. B60J 7/10

(52) U.S. Cl. CPC B60J 7/104
USPC 296/107.02

(57) ABSTRACT

The Stroller Canopy Shade provides its occupant shading and shielding protection from outdoor elements. The shade easily attaches to and detaches from multiple styles of strollers. The shade is comprised of cotton, is reversible, and has two shades, left and right sides, which provide optional variations of protection. The two shades fasten together in front. Shade fastens to stroller handle via straps and an internal clip attaches to the canopy. Each shade is able to be fastened to the stroller handle so that it can be put up and out of the way when not in use or fastened to the stroller leg for stability and protection from debris during windy weather via a strap on the lower end of the shade. A method of protecting a child from outdoor elements by covering the open front area of a stroller by means of attaching a multifunctional shading and shielding device.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to traditional and jogging strollers, of various styles, and the accessories that shade and shield which aid in the full body protection of children from the outdoor elements.

Strollers are made in a variety of styles, shapes, and sizes all having a frame on which wheels, a seat, handle and a canopy are attached.

The purpose of the canopy is to shade the occupant from the sun, however, most canopies offer insignificant coverage, allowing the occupant to be exposed to the harmful aspect of the sun, and also of other uncomfortable outdoor elements.

Due to the canopy's insufficient coverage from the sun, there is a need for additional protection of the strollers occupant.

### BRIEF SUMMARY OF THE INVENTION

The primary object is for the stroller canopy shade to provide full body coverage from the sun and other outdoor elements, having shades that cover the front opening of the stroller from each side frame to the other, and covering from the canopy to the bottom front frame of the stroller.

Another object is to easily attach and detach from the strollers canopy.

Yet Another object is to offer two shades, therefore allowing for the amount of protection needed, having one shade down and one shade up, while enabling the occupant to view their surroundings and enjoy fresh air.

Yet another object is having a desirable fabric print on each side, front and back, enabling the stroller canopy shade to be reversible.

Still another object is that the stroller canopy shade has a flexible internal clip, located inside the top of the shade, that allows the shade to easily attach and detach from the stroller canopy, aiding against the occupant from pulling it off the stroller canopy, and is accessible regardless of whether the front or back side is being used.

Another object of the stroller canopy shade is that it is made from quality light weight material that allows for adequate airflow even during full usage with both shades down in the attached position.

Another object is that it has easy functionality being a one piece device with no additional hardware that attaches to the stroller or causing any damage to the stroller.

Yet another object is the stroller canopy shade can easily be stored and transported with minimal space required.

### BRIEF DESCRIPTION OF THE SEVERAL VIEWS OF THE DRAWINGS

The drawings are representations intending to portray the invention in it's various functions and are not necessarily to scale. The drawings are intended to show the unique aspects of it's utility and embodiment of the stroller canopy shade.

FIG 1. is a perspective view of the stroller canopy shade attached to a traditional stroller, with left and right shades in the down position, having nylon webbing straps utilizing Velcro as the fastening means attached to the stroller handle.

FIG. 2 is a perspective view of the stroller canopy shade attached to a traditional stroll, with the left and right shades in the down position, having alternative fastening means by which in this drawing it utilizes zippers as its fastening means.

FIG. 3 is a side angled perspective view of the stroller canopy shade attached to a traditional stroller having the left shade up and attached to the stroller handle.

FIG. 4 is a side angled perspective view of the stroller canopy shade attached to a traditional stroller having both the left and right shades in the down position in it's fully protective state.

FIG. 5 is a perspective view of the stroller canopy shade detached from a stroller.

### DETAILED DESCRIPTION OF THE INVENTION

Detailed description of the embodiments of this invention are herein directed to an easily attachable and detachable stroller canopy shade for either a traditional stroller or a jogging stroller and their conventional equivalents. In these embodiments, the attachable stroller canopy shade features two shades, a right and left shade, that offers variable options of protection and fully covers the front opening of the stroller, vertically and horizontally, hereby enabling its occupant protection from the sun and other outdoor elements.

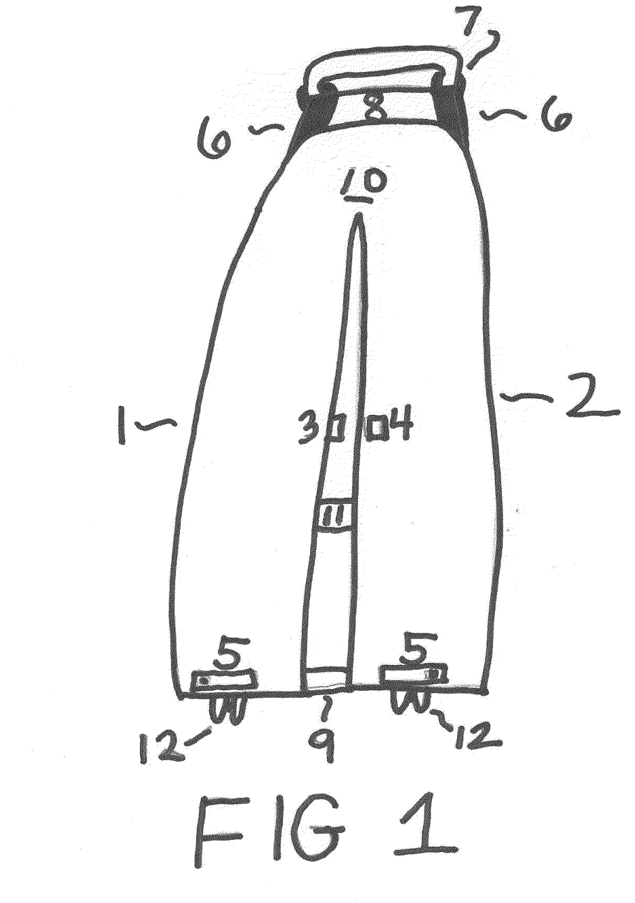

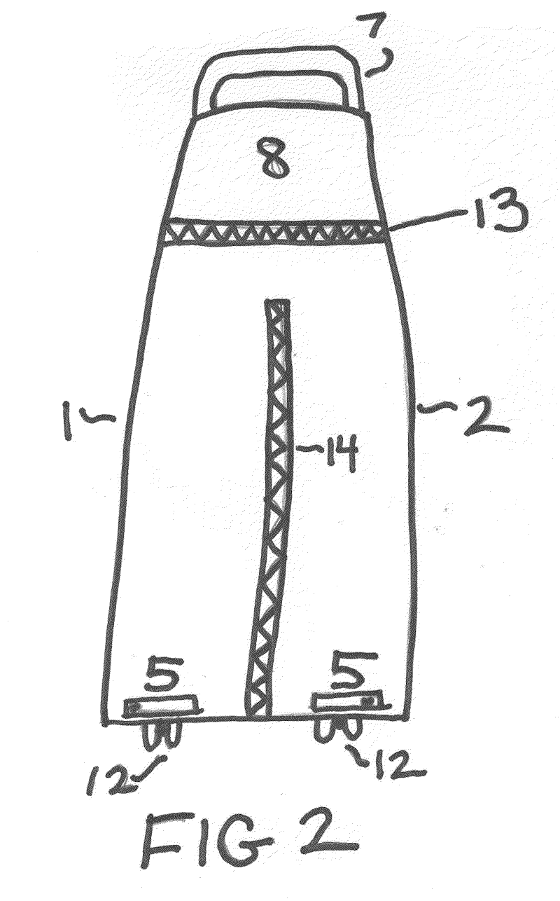

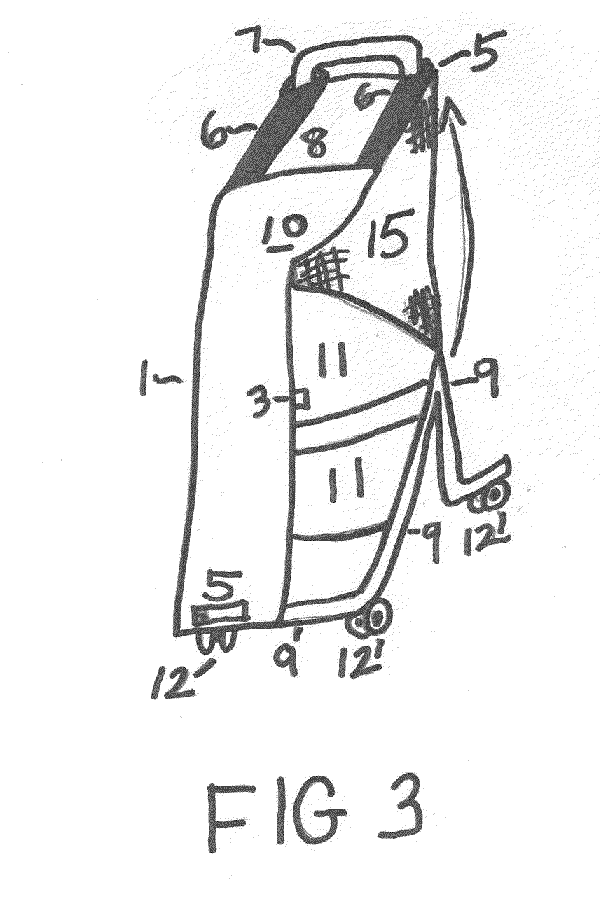

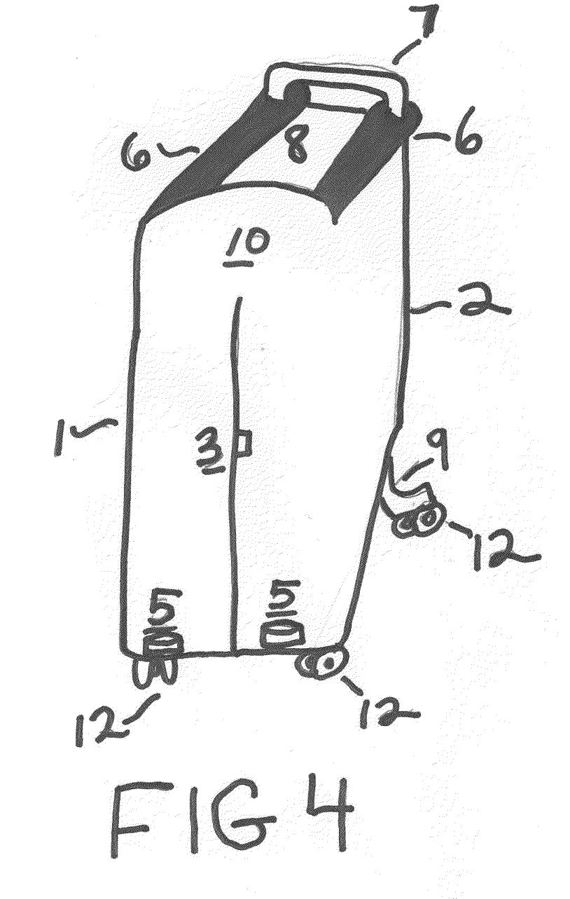

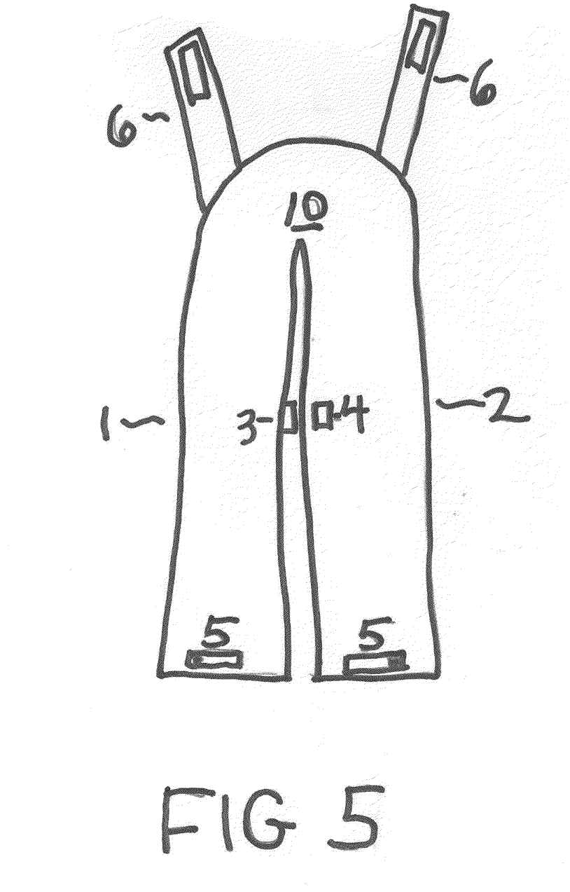

FIG. 1 illustrates the perspective view of the invention attached to a traditional stroller with the left shade 2 and the right shade 1 down having its two nylon webbing straps 6 that utilize Velcro fasteners for this illustration, which go over the strollers canopy 8 and fasten around the strollers handle 7. Located at the top center of the stroller canopy shade is where the internal flexible clip 10 is located which easily attaches to the strollers canopy to aid against the occupant from pulling it off of the stroller canopy. In the center opening of the shade is the nylon webbing tab 3 that is approximately 1 inch by 1 inch that utilizes the hook side of Velcro and directly across from it is the loop side of the Velcro 4 which allows for the fastening of the shades for optimal protection. On the bottom center of each shade are the nylon webbing straps 5 that utilize Velcro hook and loop to fasten the shade either up onto the stroller handle 7 when the shade is not needed on a particular side thus allowing for the occupant to view their surroundings, or the same nylon webbing strap 5 can also be used to fasten the shade to the stroller leg on the bottom frame 9 for stability during cold or windy days, hereby protecting its occupant from cold wind and flying debris. FIG. 2 illustrates an alternative means of fastening the stroller canopy shade to the stroller canopy by using zippers 13 in this illustration. The stroller shades can also be made to utilize a zipper 14 as the means for fastening the left shade 2 and the right shade 1 together. FIG. 3 shows the left side angle perspective view of the stroller canopy shade attached to a traditional stroller having its left shade 2 up and fastened to the strollers handle 7. Also shown here is the backside of the stroller canopy shade 15 whereby having both sides of the stroller canopy shade comprised of quality fashion cotton prints, enables this stroller canopy shade to be reversible. Both sides of the stroller canopy shade have the same variable functionality of all said fasteners 3, 4, 5, 6, and 10, and optional shading capabilities. FIG. 4 illustrates the stroller canopy with both the right shade 1 and left shade 2 in the down position and in its fully protective form. FIG. 5 illustrates the detached stroller canopy shade and its perspective parts. The right shade 1 and left shade 2 are able to be used in the down position when the sun is shining at the occupant from various angles, and can be fastened to the strollers bottom frame for protection and stability when it is cold or windy outside, or for privacy for the napping occupant. The two nylon webbing straps located at the top right and left of the stroller canopy shade are the fastening means to attach the stroller canopy shade to the stroller canopy. Also aiding in fastening to the stroller canopy is the internal flexible clip 10 located inside the top center of the stroller canopy shade. A pocket area has been created to stabilize the flexible clip to its location. The internal clip is able to be utilized regardless of which side of the stroller shade is being used. The front and back cotton fabrics have been machine stitched together in the traditional way, right sides together, having the two top nylon webbing straps 6 and the center nylon webbing tab 3, back stitched multiple times for durability and safety. Upon clipping corners and turning, the stroller canopy shades edges are neatly pinned and top stitched. Before closing the opening, a four inch by 8 inch pocket area is created 10 in the top center of the stroller canopy shade that leaves enough room for the flexible clip to flip over and be utilized when the reversible side of the stroller canopy shade is in use. The opening is then stitched closed. Across from the nylon webbing tab 3 located in the middle center edge of the right shade 1, the loop piece of Velcro is sewn directly across onto the left shade 2 enabling the right 1 and left 2 shades to be fastened, allowing for optimal protection from the outdoor elements. Lastly, four one inch by seven inch nylon webbing straps with Velcro fasteners will be sewn onto the bottom front and back of the stroller canopy shades, one on the front and back of each shade 5, allowing it to be fastened to either the strollers handle 7 or its bottom leg frame 9 if so desired and for optional outdoor element protection.

1. A stroller canopy shade comprising: a left and right side shade that is connected at the top wherein making it one piece, mainly comprised of cotton material, which fastens to the strollers' canopy via a zipper, two straps or other fasteners, four lower fastening straps, an internal fastening clip, a center tab to fasten left and right shades together and having cotton fabric on both the front and back side of the shade making it reversible.

2. A stroller canopy shade according to claim 1, wherein said stroller canopy shade has a left and right side shade connected at the top making it one piece which is comprised of cotton material or its conventional equivalents.

3. A stroller canopy shade according to claim 1, wherein said stroller canopy shade can be attached to and detached from the stroller canopy via zipper, snaps or their conventional equivalents that fasten to the stroller canopy, or by two straps located at the top left and right sides which are composed of nylon webbing or its conventional equivalents, having Velcro, tri glide slides or their conventional equivalents that fasten to the stroller handle.

4. A stroller canopy shade according to claim 1, wherein said stroller canopy shade has one fastening strap located at the bottom of each shade, having four total, one on the front and one on the back side of the left and right shades, which allow user to fasten the left and right shade to the strollers handle when not in use, via a nylon webbing strap or its conventional equivalents, having Velcro or its conventional equivalents as its fastening means, enabling the occupant to view their surroundings and still be shaded by the opposing shade.

5. A stroller canopy shade according to claim 1, wherein said stroller canopy shade has an internal fastening clip located the in the upper internal portion of the shade which is made from a flexible plastic or rubber material, or their conventional equivalents, enabling it to easily attach to and detach from the strollers canopy by the user, wherein it also aids against the occupant from pulling said stroller canopy shade from strollers canopy.

6. A stroller canopy shade according to claim 1, wherein said stroller canopy shade has a small center tab made of nylon webbing or its conventional equivalents, having a piece of Velcro or its conventional equivalents on the tab and the opposing piece of Velcro on the opposite shade hereby enabling user to attach the left and right sides of the shade together for optimal use, optionally the shades may be connected vertically with a zipper, snaps or their conventional equivalents.

7. A stroller canopy shade according to claim 1, wherein said stroller canopy shade is constructed of two pieces of cotton fabric, front and back, enabling either side of the stroller canopy shade to be used, therefore having two sides, making it reversible.

8. A stroller canopy shade according to claim 4, wherein said stroller canopy shade has one fastening strap located at the bottom of each shade, one on the front and one on the back side of the left and right shades, which enable the user to fasten either the left or right shade to the strollers leg for stability during windy or cold weather, via a nylon webbing strap or its conventional equivalents, having Velcro or its conventional equivalents as its fastening means, enabling the occupant to be protected from the wind and flying debris.

9. The stroller canopy shade according to claims 2, is a method of shading and shielding the occupant from outdoor elements.

10. A stroller canopy shade according to claim 1, wherein said stroller canopy shade is a one piece device having two shades that can be used on various styles of strollers.

11. A stroller canopy shade according to claim 1, wherein said stroller canopy shade is of a sufficient width to extend from one side of the stroller frame to the opposite side of the stroller frame, and sufficient length to extend from the stroller canopy to the bottom frame just above the front wheel or wheels on its respective stroller.

12. A stroller canopy shade according to claim 11, wherein the said stroller canopy shade enables occupant full body protection from the outdoor elements, coming from all angles, yet allowing for adequate airflow.
